(19) United States
(12) Patent Application Publication
(10) Pub. No.: US 2025/0298224 A1
(43) Pub. Date: Sep. 25, 2025

(54) WIDE ANGLE ZOOM PROJECTION LENS

(71) Applicant: SUN YANG OPTICS DEVELOPMENT CO., LTD., Taoyuan City (TW)

(72) Inventors: Yi Hua LIN, Taoyuan City (TW); Yu Hung CHOU, Taoyuan City (TW); Sheng Che WU, Taoyuan City (TW)

(21) Appl. No.: 18/615,283

(22) Filed: Mar. 25, 2024

(51) Int. Cl. G02B 13/16; G02B 15/14

(52) U.S. Cl. CPC G02B 13/16; G02B 15/1465

(57) ABSTRACT

A wide angle zoom projection lens, which from the magnifying side to the narrowing side of the lens sequentially comprising: a first lens group with negative diopter, a second lens group, a third lens group with positive diopter, a fourth lens group with positive diopter, a fifth lens group with positive diopter, a sixth lens group with positive diopter, and an aperture in the lens; during the zooming, the first lens group and the sixth lens group are fixed, the second to fifth lens groups move along the optical axis to achieve changes in focal length; The front lens of the first lens group closest to the magnifying side of the lens is an aspherical lens with negative diopter to achieve a wide angle effect.

### BACKGROUND OF THE INVENTION

### 1. Field of the Invention

The present invention relates to a wide angle zoom projection lens, particularly to one that meets the requirements of high brightness and zoom projection and maintain the quality of projection imaging.

### 2. Description of the Related Art

Wide angle projectors have small projection distance requirements and can project large images at short distances, making them easy to install. They only need to be placed in front of the projection screen. Compared with conventional projectors, they have the advantages of saving space and being easy to install. Furthermore, in addition to meeting the aforementioned requirements for high brightness projection, lens groups usually required zooming depending on the installation position of the projector to adjust the projection image to an appropriate size. Therefore, making the projection lens meet the projection requirements of wide angle and zoom at the same time, and can also take into account the projection imaging quality are the goal of the present invention.

### SUMMARY OF THE INVENTION

A primary objective of the present invention is to provide a wide angle zoom projection lens which meet the projection requirements of wide angle projection and zoom at the same time.

To achieve the objects mentioned above, the present invention includes a lens with six lens groups, which from the magnifying side to the narrowing side of the lens sequentially comprising:
a first lens group with negative diopter, a second lens group, a third lens group with positive diopter, a fourth lens group with positive diopter, a fifth lens group with positive diopter, a sixth lens group with positive diopter, and an aperture in the lens; during the zooming, the first lens group and the sixth lens group are fixed, the second to fifth lens groups move along the optical axis to achieve changes in focal length; The front lens of the first lens group closest to the magnifying side of the lens is an aspherical lens with negative diopter to achieve a wide angle effect, the narrowing side of the lens has telecentric characteristics, and 1.3≤Ww/Dw≤2.5, Ww is the projection screen width of wide angle end, Dw is the projection distance at the wide angle end; wherein 1.05≤|ft/fw|≤1.7, 1.2≤|f1/fw|≤1.7, 4.5≤|f5/fw|≤35.0, 4.0≤Bf/fw≤5.0, ft is the focal length of the entire lens at the telephoto end, and fw is the focal length of the entire lens at the wide angle end, f1 is the focal length of the first lens group, and f5 is the focal length of the fifth lens group, Bf is the back focal length when converted to air; CA/IHm≤12, CA is the effective diameter of the front lens, and IHm is the maximum image height on the narrowing side of the lens.

Moreover, an aperture is set between the fourth lens group and the fifth lens group, and the F value of the aperture is between 1.7 and 2.6. Also, the first lens group has at least one glass lens with a refractive index≥1.75 and at least one glass lens with an Abbe number≥55, and the fifth lens group has at least one doublet, at least one glass lens with a refractive index≥1.75 and at least one glass lens with Abbe number≥60. Furthermore, the first lens group can be integrated into a group or divided into multiple groups to adjust focus and field curvature.

Also, the present invention includes a lens with five lens groups, which from the magnifying side to the narrowing side of the lens sequentially comprising: a first lens group with negative diopter, a second lens group, a third lens group with positive diopter, a fourth lens group with positive diopter, a fifth lens group with positive diopter, and an aperture in the lens; during the zooming, the first lens group and the fifth lens group are fixed, the second to fourth lens groups move along the optical axis to achieve changes in focal length; The front lens of the first lens group closest to the magnifying side of the lens is an aspherical lens with negative diopter to achieve a wide angle effect, the narrowing side of the lens has telecentric characteristics, and 1.3≤Ww/Dw≤2.5, Ww is the projection screen width of wide angle end, Dw is the projection distance at the wide angle end; wherein 1.05≤|ft/fw|≤1.3, 3≤|f1/fw|≤5, 4.5≤|f4/fw|≤50, 4.0≤Bf/fw≤5.0, ft is the focal length of the entire lens at the telephoto end, and fw is the focal length of the entire lens at the wide angle end, f1 is the focal length of the first lens group, and f4 is the focal length of the fourth lens group, Bf is the back focal length when converted to air; CA/IHm≤12, CA is the effective diameter of the front lens, and IHm is the maximum image height on the narrowing side of the lens.

Moreover, an aperture is set between the third lens group and the fourth lens group, and the F value of the aperture is between 1.7 and 2.6. Also, the first lens group has at least one glass lens with a refractive index≥1.75 and at least one glass lens with an Abbe number≥55, and the fourth lens group has at least one doublet, at least one glass lens with a refractive index≥1.75 and at least one glass lens with Abbe number≥60. Furthermore, the first lens group can be integrated into a group or divided into multiple groups to adjust focus and field curvature.

### BRIEF DESCRIPTION OF THE DRAWINGS

FIG. 1A is a schematic diagram illustrating lenses arrangement of the wide angle end of the first embodiment of the present invention;

FIG. 1B is a schematic diagram illustrating lenses arrangement of the telephoto end of the first embodiment of the present invention;

FIG. 1C is a graph illustrating the ray aberration diagram of the wide angle end of the first embodiment of the present invention;

FIG. 1D is a graph illustrating the ray aberration diagram of the wide angle end of the first embodiment of the present invention;

FIG. 2A is a schematic diagram illustrating lenses arrangement of the wide angle end of the second embodiment of the present invention;

FIG. 2B is a schematic diagram illustrating lenses arrangement of the telephoto end of the second embodiment of the present invention;

FIG. 2C is a graph illustrating the ray aberration diagram of the wide angle end of the second embodiment of the present invention;

FIG. 2D is a graph illustrating the ray aberration diagram of the wide angle end of the second embodiment of the present invention;

FIG. 3A is a schematic diagram illustrating lenses arrangement of the wide angle end of the third embodiment of the present invention;

FIG. 3B is a schematic diagram illustrating lenses arrangement of the telephoto end of the third embodiment of the present invention;

FIG. 3C is a graph illustrating the ray aberration diagram of the wide angle end of the third embodiment of the present invention;

FIG. 3D is a graph illustrating the ray aberration diagram of the wide angle end of the third embodiment of the present invention;

FIG. 4A is a schematic diagram illustrating lenses arrangement of the wide angle end of the fourth embodiment of the present invention;

FIG. 4B is a schematic diagram illustrating lenses arrangement of the telephoto end of the fourth embodiment of the present invention;

FIG. 4C is a graph illustrating the ray aberration diagram of the wide angle end of the fourth embodiment of the present invention;

FIG. 4D is a graph illustrating the ray aberration diagram of the wide angle end of the fourth embodiment of the present invention;

FIG. 5A is a schematic diagram illustrating lenses arrangement of the wide angle end of the fifth embodiment of the present invention;

FIG. 5B is a schematic diagram illustrating lenses arrangement of the telephoto end of the fifth embodiment of the present invention;

FIG. 5C is a graph illustrating the ray aberration diagram of the wide angle end of the fifth embodiment of the present invention;

FIG. 5D is a graph illustrating the ray aberration diagram of the wide angle end of the fifth embodiment of the present invention.

### DETAILED DESCRIPTION OF THE PREFERRED EMBODIMENT

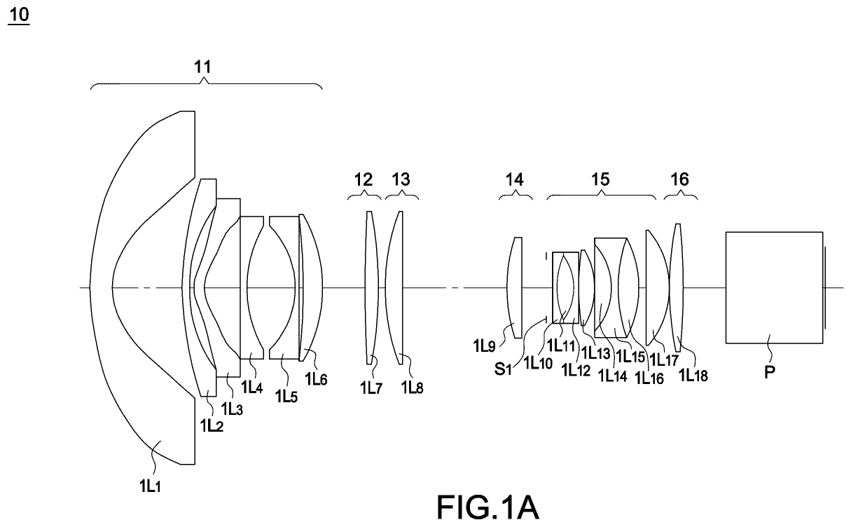

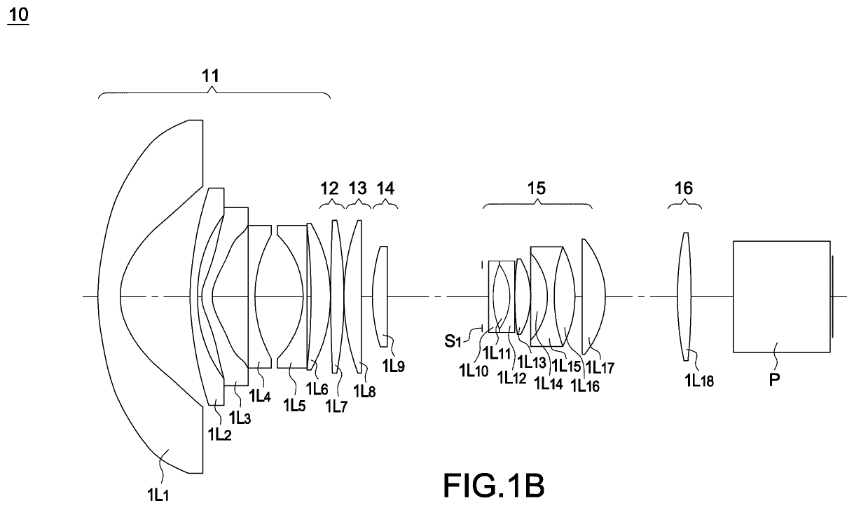

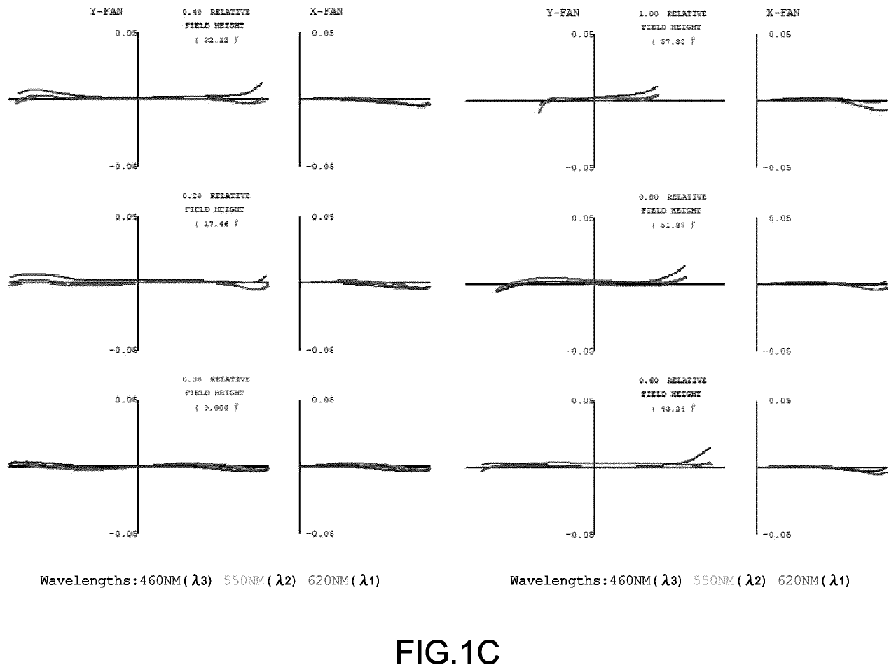

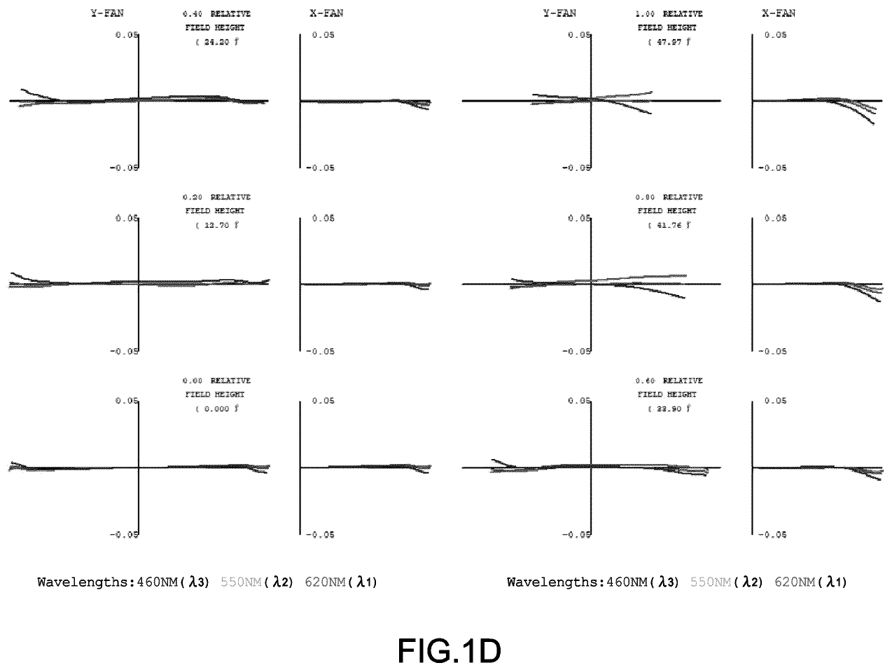

Referring to FIGS. 1A and 1B, the first embodiment of the present invention includes a wide angle zoom projection lens 10, which from the magnifying side to the narrowing side of the lens sequentially comprising: a first lens group 11 with negative diopter, a second lens group 12, a third lens group 13 with positive diopter, a fourth lens group 14 with positive diopter, a fifth lens group 15 with positive diopter, a sixth lens group 16 with positive diopter, and a prism P, then an aperture S1 is arranged between the fourth lens group 14 and the fifth lens group 15 or in the fifth lens group 15, the F value of the aperture S1 is between 1.8˜2.0; during the zooming, the first lens group 11 and the sixth lens group 16 are fixed, the second 12 to fifth lens groups 15 move along the optical axis to achieve changes in focal length; The front lens of the first lens group 11 closest to the magnifying side of the lens is an aspherical lens with negative diopter to achieve a wide angle effect, the narrowing side of the lens has telecentric characteristics; wherein, Ww/Dw=1.980, |ft/fw|=1.396, |f1/fw|=1.532, |f5/fw|=20.875, Bf/fw=4.709, CA/IHm=8.819, Ww is the projection screen width of wide angle end, Dw is the projection distance at the wide angle end, ft is the focal length of the entire lens at the telephoto end, fw is the focal length of the entire lens at the wide angle end, f1 is the focal length of the first lens group, f5 is the focal length of the fifth lens group, Bf is the back focal length when converted to air, CA is the effective diameter of the front lens, and IHm is the maximum image height on the narrowing side of the lens.

The lens parameters design of the wide angle zoom projection lens 10 are shown in Table 1A, Table 1B and Table 1C below; Wherein 1L1R1 is the magnifying side surface R1 of the first lens 1L1, and 1L1R2 is the narrowing side surface R2 of the first lens 1L1, 1L2R1 is the magnifying side surface R1 of the second lens 1L2, 1L2R2 is the narrowing side surface R2 of the second lens 1L2, . . . 1L18R1 is the magnifying side surface R1 of the eighteenth lens 1L18, 1L18R2 is the narrowing side surface R2 of the eighteenth lens 1L18, and so on; and the tenth lens 1L10, the eleventh lens 1L11 and the twelfth lens 1L12 can form a doublet, and the fourteenth lens 1L14, the fifteenth lens 1L15 and the sixteenth lens 1L16 can form a doublet.

1A

| Embodiment 1 | Radius(mm) | Thickness(mm) | Nd | Vd |
|---|---|---|---|---|
| 1L1R1(A) | 62.70 | 7.00 | 1.51 | 56.3 |
| 1L1R2(A) | 19.10 | 24.40 | | |
| 1L2R1 | 103.80 | 2.50 | 1.85 | 23.8 |
| 1L2R2 | 44.90 | 1.60 | | |
| 1L3R1(A) | 15.70 | 3.00 | 1.51 | 56.3 |
| 1L3R2(A) | 12.90 | 11.20 | | |
| 1L4R1 | −210.00 | 2.00 | 1.60 | 65.5 |
| 1L4R2 | 33.70 | 14.90 | | |
| 1L5R1 | −24.20 | 1.80 | 1.50 | 81.6 |
| 1L5R2 | −245.50 | 1.00 | | |
| 1L6R1 | −125.00 | 5.70 | 1.76 | 27.5 |
| 1L6R2(*) | −40.30 | 12.70 | | |
| 1L7R1 | 502.70 | 4.70 | 1.69 | 31.2 |
| 1L7R2(*) | −119.00 | 2.60 | | |
| 1L8R1 | 64.10 | 7.50 | 1.75 | 49.2 |
| 1L8R2(*) | Inf. | 33.20 | | |
| 1L9R1 | 65.40 | 4.70 | 1.52 | 64.1 |
| 1L9R2(*) | −259.00 | 7.20 | | |
| Stop(S1) | Inf. | 3.20 | | |
| 1L10R1 | 217.20 | 1.00 | 1.92 | 35.3 |
| 1L11R1 | 24.00 | 6.00 | 1.51 | 61.0 |
| 1L12R1 | −16.60 | 1.00 | 1.96 | 32.3 |
| 1L12R2 | 201.80 | 0.20 | | |
| 1L13R1(A) | 57.30 | 5.20 | 1.52 | 64.0 |
| 1L13R2(A) | −22.50 | 0.20 | | |
| 1L14R1 | −417.10 | 5.50 | 1.51 | 61.0 |
| 1L15R1 | −18.10 | 1.50 | 1.89 | 40.9 |
| 1L16R1 | 58.60 | 6.20 | 1.49 | 70.4 |
| 1L16R2 | −31.80 | 2.60 | | |
| 1L17R1 | 277.70 | 7.90 | 1.44 | 94.6 |
| 1L17R2(*) | −27.10 | 0.30 | | |
| 1L18R1 | 98.40 | 4.40 | 1.93 | 20.9 |
| 1L18R2 | −157.10 | 14.60 | | |
| Prism | Inf. | 31.40 | 1.52 | 64.2 |

1B

| Zoom | Wide | Tele |
|---|---|---|
| 1L6R2 | 12.70 | 1.80 |
| 1L7R2 | 2.60 | 0.20 |
| 1L8R2 | 33.20 | 12.50 |
| 1L9R2 | 7.20 | 24.40 |
| 1L17R2 | 0.30 | 16.50 |

1C

| (A) | | | | | | |
|---|---|---|---|---|---|---|
| Aspheric | | | | | | |
| coefficient | 1L1R1 | 1L1R2 | 1L3R1 | 1L3R2 | 1L13R1 | 1L13R2 |
| K | −33.94 | −0.74 | −0.91 | −2.67 | −15.24 | 1.79 |
| A4 | 7.50E−06 | −1.15E−05 | −6.06E−05 | 2.48E−05 | −1.21E−06 | 1.81E−05 |
| A6 | −1.14E−08 | 5.63E−08 | −2.22E−07 | −7.00E−07 | 6.42E−08 | 8.30E−08 |
| A8 | 1.18E−11 | −2.22E−10 | 1.50E−09 | 4.71E−09 | −1.42E−09 | 3.83E−10 |
| A10 | −7.23E−15 | 4.35E−13 | −3.70E−12 | −1.76E−11 | 1.56E−11 | −5.13E−12 |
| A12 | 2.67E−18 | −4.71E−16 | 4.77E−15 | 4.19E−14 | −7.62E−14 | 6.87E−14 |
| A14 | −5.49E−22 | 2.61E−19 | −3.22E−18 | −5.87E−17 | 9.72E−17 | −1.76E−16 |
| A16 | 4.89E−26 | −5.85E−23 | 8.72E−22 | 3.71E−20 | 0 | 0 |

The wide angle end of the wide angle zoom projection lens 10 uses a first wavelength λ1 of 620 nm, a second wavelength λ2 of 550 nm and a third wavelength λ3 of 460 nm to match relative field heights, which are 0.00, 0.20, 0.40, 0.60, 0.80, 1.00 to respectively simulate the corresponding ray aberration FIG. 1C, and viewing the Y-FAN ray aberration and the X-FAN field aberrations diagram can tell the maximum aberration at each field of view point is controlled within the range of −0.02 mm˜0.02 mm; The wide angle end of the wide angle zoom projection lens 10 uses a first wavelength λ1 of 620 nm, a second wavelength λ2 of 550 nm and a third wavelength λ3 of 460 nm to match relative field heights, which are 0.00, 0.20, 0.40, 0.60, 0.80, 1.00 to respectively simulate the corresponding ray aberration FIG. 1D, and viewing the Y-FAN ray aberration and the X-FAN field aberrations diagram can tell the maximum aberration at each field of view point is controlled within the range of −0.03 mm˜0.02 mm.

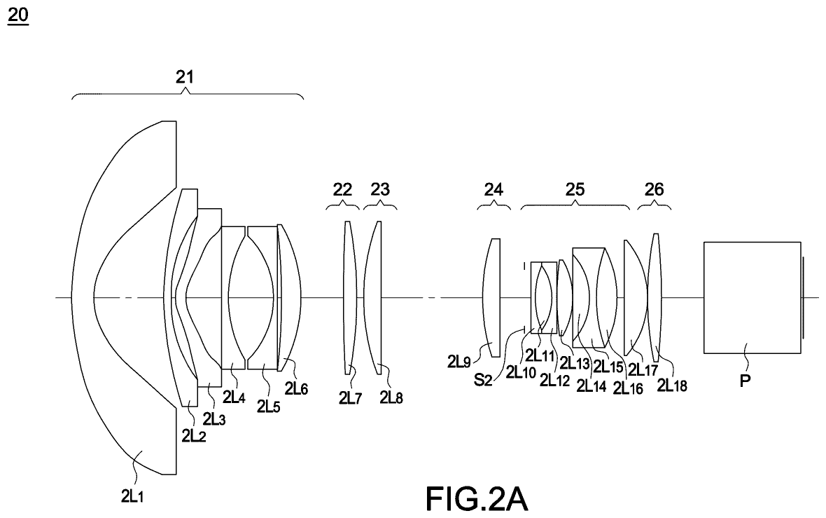

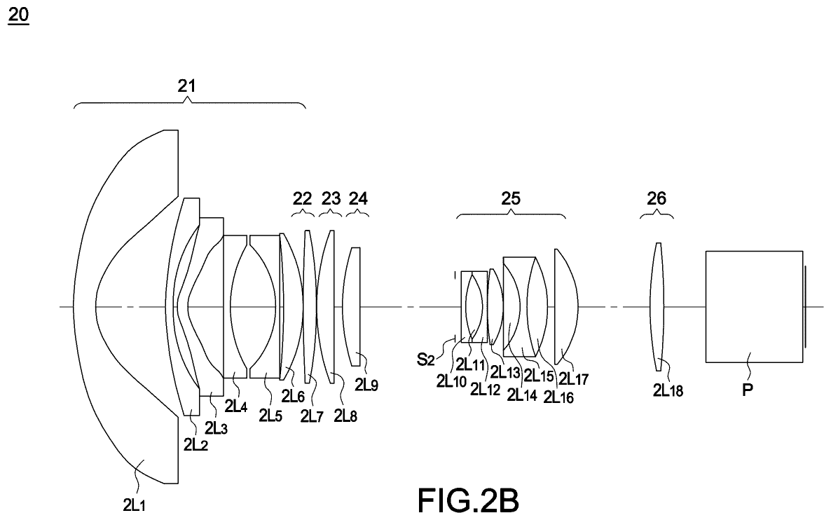

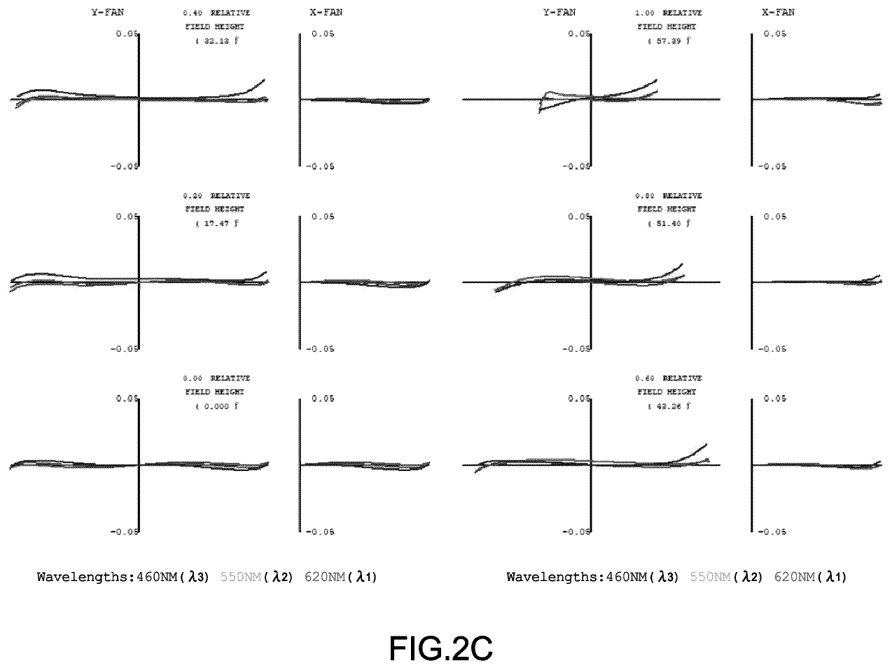

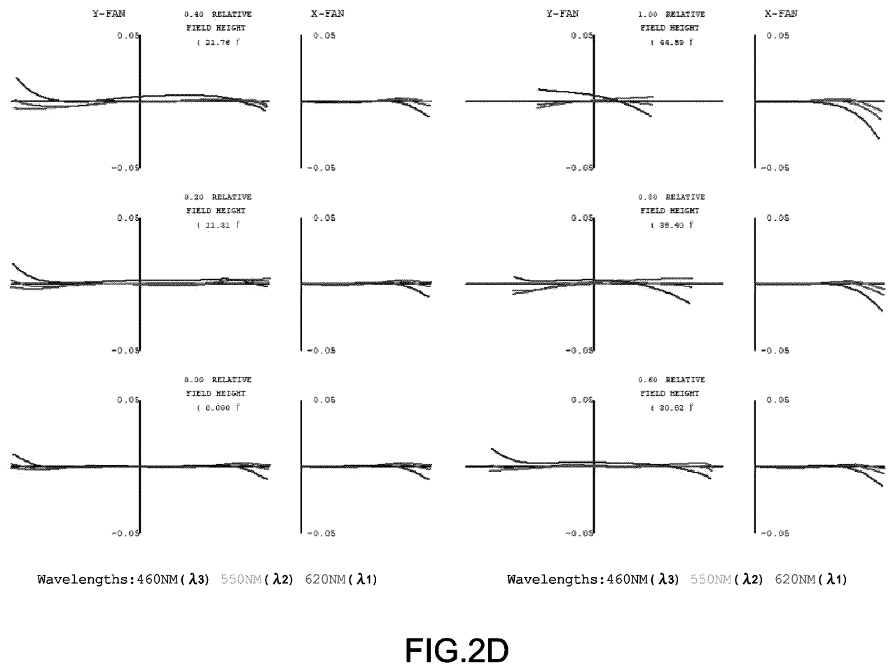

Referring to FIGS. 2A and 2B, the second embodiment of the present invention includes a wide angle zoom projection lens 20, which from the magnifying side to the narrowing side of the lens sequentially comprising: a first lens group 21 with negative diopter, a second lens group 22, a third lens group 23 with positive diopter, a fourth lens group 24 with positive diopter, a fifth lens group 25 with positive diopter, a sixth lens group 26 with positive diopter, and a prism P, then an aperture S2 is arranged between the fourth lens group 24 and the fifth lens group 25 or arranged in the fifth lens group 25, the F value of the aperture S2 is between 1.8˜2.09; during the zooming, the first lens group 21 and the sixth lens group 26 are fixed, the second 22 to fifth lens groups 25 move along the optical axis to achieve changes in focal length; The front lens of the first lens group 21 closest to the magnifying side of the lens is an aspherical lens with negative diopter to achieve a wide angle effect, the narrowing side of the lens has telecentric characteristics; wherein, Ww/Dw=1.981, |ft/fw|=1.574, |f1/fw|=1.561, |f5/fw|=19.683, Bf/fw=4.709, CA/IHm=8.667, Ww is the projection screen width of wide angle end, Dw is the projection distance at the wide angle end, ft is the focal length of the entire lens at the telephoto end, fw is the focal length of the entire lens at the wide angle end, f1 is the focal length of the first lens group, f5 is the focal length of the fifth lens group, Bf is the back focal length when converted to air, CA is the effective diameter of the front lens, and IHm is the maximum image height on the narrowing side of the lens.

The lens parameters design of the wide angle zoom projection lens 20 are shown in Table 2A, Table 2B and Table 2C below; Wherein 2L1R1 is the magnifying side surface R1 of the first lens 2L1, and 2L1R2 is the narrowing side surface R2 of the first lens 2L1, 2L2R1 is the magnifying side surface R1 of the second lens 2L2, 2L2R2 is the narrowing side surface R2 of the second lens 2L2, . . . 2L18R1 is the magnifying side surface R1 of the eighteenth lens 2L18, 2L18R2 is the narrowing side surface R2 of the eighteenth lens 2L18, and so on; and the tenth lens 2L10, the eleventh lens 2L11 and the twelfth lens 2L12 can form a doublet, and the fourteenth lens 2L14, the fifteenth lens 2L15 and the sixteenth lens 2L16 can form a doublet.

2A

| Embodiment2 | Radius(mm) | Thickness(mm) | Nd | Vd |
|---|---|---|---|---|
| 2L1R1(A) | 62.90 | 7.00 | 1.51 | 56.3 |
| 2L1R2(A) | 19.00 | 22.70 | | |
| 2L2R1 | 96.20 | 2.50 | 1.85 | 23.8 |
| 2L2R2 | 43.80 | 1.40 | | |
| 2L3R1(A) | 14.50 | 3.00 | 1.51 | 56.3 |
| 2L3R2(A) | 11.90 | 12.10 | | |
| 2L4R1 | −230.00 | 2.00 | 1.60 | 65.5 |
| 2L4R2 | 35.90 | 14.50 | | |
| 2L5R1 | −24.90 | 1.80 | 1.50 | 81.6 |
| 2L5R2 | −1239.80 | 1.20 | | |
| 2L6R1 | −168.70 | 5.90 | 1.76 | 27.5 |
| 2L6R2(*) | −42.30 | 13.70 | | |
| 2L7R1 | 343.60 | 4.30 | 1.69 | 31.2 |
| 2L7R2(*) | −131.20 | 2.50 | | |
| 2L8R1 | 65.00 | 5.60 | 1.75 | 49.2 |
| 2L8R2(*) | Inf. | 33.40 | | |
| 2L9R1 | 66.80 | 5.60 | 1.52 | 64.1 |
| 2L9R2(*) | −252.90 | 7.20 | | |
| Stop(S2) | Inf. | 2.30 | | |
| 2L10R1 | 192.00 | 1.00 | 1.92 | 35.3 |
| 2L11R1 | 23.50 | 6.00 | 1.51 | 61.0 |
| 2L12R1 | −16.80 | 1.00 | 1.96 | 32.3 |
| 2L12R2 | 182.80 | 0.20 | | |
| 2L13R1(A) | 56.80 | 5.10 | 1.52 | 64.0 |
| 2L13R2(A) | −22.60 | 0.20 | | |
| 2L14R1 | −402.10 | 5.50 | 1.51 | 61.0 |
| 2L15R1 | −17.90 | 2.40 | 1.89 | 40.9 |
| 2L16R1 | 59.00 | 6.30 | 1.49 | 70.4 |
| 2L16R2 | −32.00 | 2.10 | | |
| 2L17R1 | 277.70 | 7.80 | 1.44 | 94.6 |
| 2L17R2(*) | −27.00 | 0.30 | | |
| 2L18R1 | 97.80 | 4.40 | 1.93 | 20.9 |
| 2L18R2 | −163.10 | 14.60 | | |
| Prism | Inf. | 31.40 | 1.52 | 64.2 |

2B

| Zoom | Wide | Tele |
|---|---|---|
| 2L6R2 | 13.70 | 0.20 |
| 2L7R2 | 2.50 | 0.20 |
| 2L8R2 | 33.40 | 3.10 |
| 2L9R2 | 7.20 | 30.10 |
| 2L17R2 | 0.30 | 23.40 |

2C

| (A) | | | | | | |
|---|---|---|---|---|---|---|
| Aspheric | | | | | | |
| coefficient | 2L1R1 | 2L1R2 | 2L3R1 | 2L3R2 | 2L13R1 | 2L13R2 |
| K | −33.58 | −0.74 | −0.94 | −2.34 | −15.22 | 1.84 |
| A4 | 7.70E−06 | −1.10E−05 | −6.20E−05 | 2.29E−05 | −5.40E−07 | 1.83E−05 |
| A6 | −1.15E−08 | 5.60E−08 | −2.20E−07 | −6.78E−07 | 4.38E−08 | 8.78E−08 |
| A8 | 1.18E−11 | −2.22E−10 | 1.47E−09 | 4.51E−09 | −1.03E−09 | 1.25E−10 |
| A10 | −7.21E−15 | 4.35E−13 | −3.58E−12 | −1.65E−11 | 1.18E−11 | −1.06E−13 |
| A12 | 2.67E−18 | −4.71E−16 | 4.60E−15 | 3.84E−14 | 6.22E−14 | 2.74E−14 |
| A14 | −5.53E−22 | 2.61E−19 | −3.06E−18 | −5.28E−17 | 9.08E−17 | −5.52E−17 |
| A16 | 4.99E−26 | −5.86E−23 | 8.10E−22 | 3.30E−20 | 0 | 0 |

The wide angle end of the wide angle zoom projection lens 20 uses a first wavelength λ1 of 620 nm, a second wavelength λ2 of 550 nm and a third wavelength λ3 of 460 nm to match relative field heights, which are 0.00, 0.20, 0.40, 0.60, 0.80, 1.00 to respectively simulate the corresponding ray aberration FIG. 2C, and viewing the Y-FAN ray aberration and the X-FAN field aberrations diagram can tell the maximum aberration at each field of view point is controlled within the range of −0.01 mm˜0.02 mm; The wide angle end of the wide angle zoom projection lens 20 uses a first wavelength λ1 of 620 nm, a second wavelength λ2 of 550 nm and a third wavelength λ3 of 460 nm to match relative field heights, which are 0.00, 0.20, 0.40, 0.60, 0.80, 1.00 to respectively simulate the corresponding ray aberration FIG. 2D, and viewing the Y-FAN ray aberration and the X-FAN field aberrations diagram can tell the maximum aberration at each field of view point is controlled within the range of −0.03 mm˜0.02 mm.

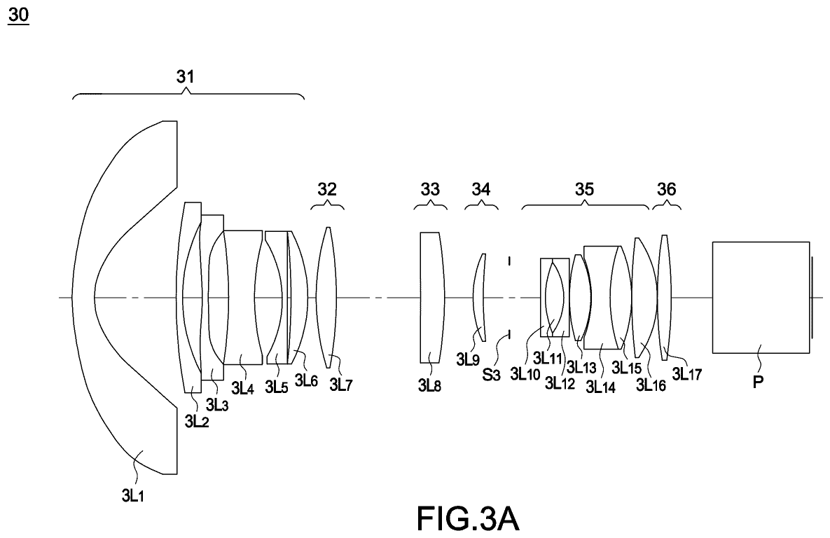

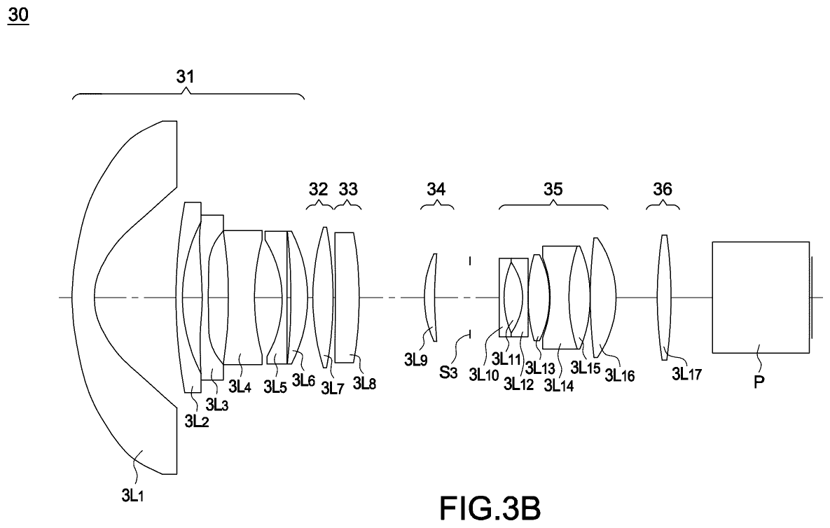

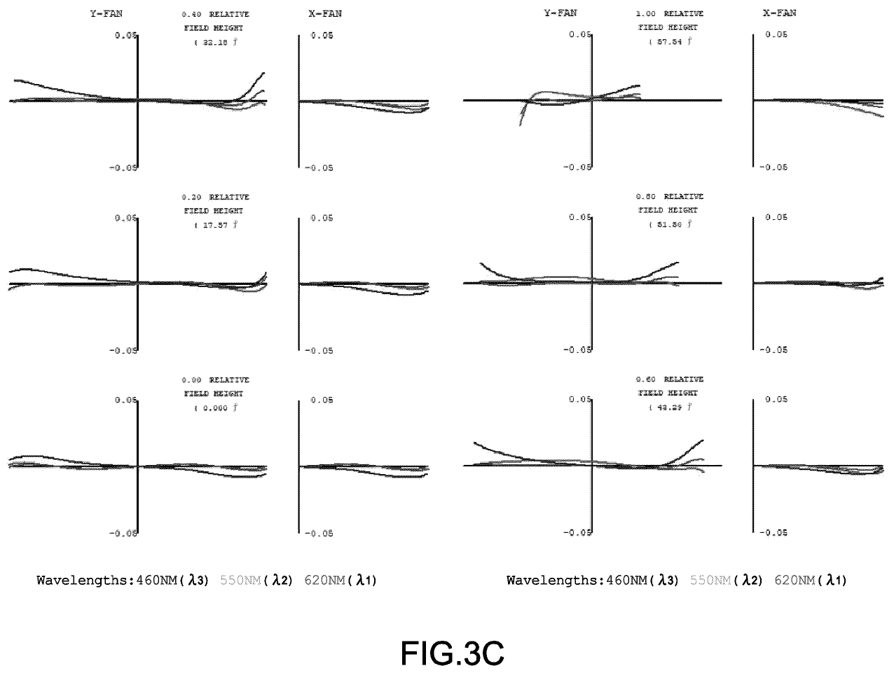

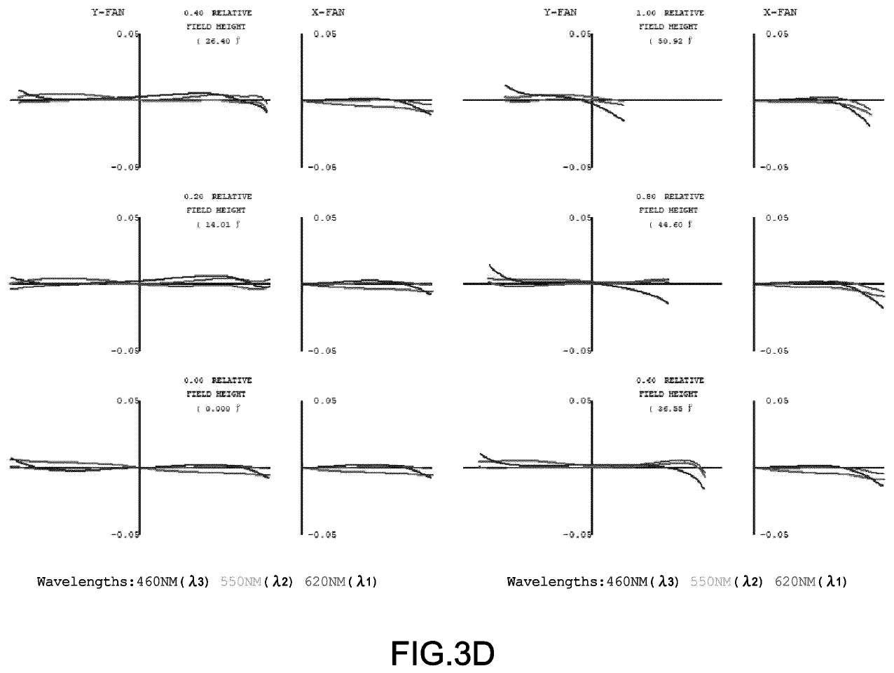

Referring to FIGS. 3A and 3B, the third embodiment of the present invention includes a wide angle zoom projection lens 30, which from the magnifying side to the narrowing side of the lens sequentially comprising: a first lens group 31 with negative diopter, a second lens group 32, a third lens group 33 with positive diopter, a fourth lens group 34 with positive diopter, a fifth lens group 35 with positive diopter, a sixth lens group 36 with positive diopter, and a prism P, then an aperture S3 is arranged between the fourth lens group 34 and the fifth lens group 35 or arranged in the fifth lens group 35, the F value of the aperture S3 is between 1.8˜1.94; during the zooming, the first lens group 31 and the sixth lens group 36 are fixed, the second 32 to fifth lens groups 35 move along the optical axis to achieve changes in focal length; The front lens of the first lens group 31 closest to the magnifying side of the lens is an aspherical lens with negative diopter to achieve a wide angle effect, the narrowing side of the lens has telecentric characteristics; wherein, Ww/Dw=1.981, |ft/fw|=1.271, |f1/fw|=1.382, |f5/fw|=32.652, Bf/fw=4.709, CA/IHm=8.698, Ww is the projection screen width of wide angle end, Dw is the projection distance at the wide angle end, ft is the focal length of the entire lens at the telephoto end, fw is the focal length of the entire lens at the wide angle end, f1 is the focal length of the first lens group, f5 is the focal length of the fifth lens group, Bf is the back focal length when converted to air, CA is the effective diameter of the front lens, and IHm is the maximum image height on the narrowing side of the lens.

The lens parameters design of the wide angle zoom projection lens 30 are shown in Table 3A, Table 3B and Table 3C below; Wherein 3L1R1 is the magnifying side surface R1 of the first lens 3L1, and 3L1R2 is the narrowing side surface R2 of the first lens 3L1, 3L2R1 is the magnifying side surface R1 of the second lens 3L2, 3L2R2 is the narrowing side surface R2 of the second lens 3L2, . . . 3L17R1 is the magnifying side surface R1 of the seventeenth lens 3L17, 3L17R2 is the narrowing side surface R2 of the seventeenth lens 3L17, and so on; and the tenth lens 3L10, the eleventh lens 3L11 and the twelfth lens 3L12 can form a doublet, and the fourteenth lens 3L14 and the fifteenth lens 3L15 can form a doublet.

3A

| Embodiment 3 | Radius(mm) | Thickness(mm) | Nd | Vd |
|---|---|---|---|---|
| 3L1R1(A) | 70.70 | 5.90 | 1.51 | 56.3 |
| 3L1R2(A) | 20.50 | 27.40 | | |
| 3L2R1 | 153.60 | 2.20 | 1.93 | 18.9 |
| 3L2R2 | 53.00 | 6.50 | | |
| 3L3R1(A) | −108.90 | 1.90 | 1.51 | 56.3 |
| 3L3R2(A) | 224.90 | 6.70 | | |
| 3L4R1 | −93.90 | 8.00 | 1.60 | 65.5 |
| 3L4R2 | 61.50 | 9.20 | | |
| 3L5R1 | −35.80 | 1.40 | 1.76 | 52.3 |
| 3L5R2 | 412.60 | 1.80 | | |
| 3L6R1 | −146.30 | 5.20 | 1.79 | 25.7 |
| 3L6R2(*) | −42.00 | 2.90 | | |
| 3L7R1 | 69.70 | 6.50 | 1.68 | 32.2 |
| 3L7R2(*) | −123.00 | 27.80 | | |
| 3L8R1 | −584.60 | 7.60 | 1.68 | 32.2 |
| 3L8R2(*) | −108.10 | 9.50 | | |
| 3L9R1 | 33.30 | 3.20 | 1.68 | 32.2 |
| 3L9R2(*) | 73.40 | 8.60 | | |
| Stop(S3) | Inf. | 9.70 | | |
| 3L10R1 | 98.00 | 1.00 | 1.91 | 31.3 |
| 3L11R1 | 18.30 | 8.00 | 1.52 | 64.2 |
| 3L12R1 | −16.10 | 1.00 | 1.91 | 31.3 |
| 3L12R2(A) | −486.50 | 0.20 | | |
| 3L13R1(A) | 54.90 | 6.70 | 1.67 | 55.4 |
| 3L13R2 | −26.40 | 0.20 | | |
| 3L14R1 | −32.20 | 5.70 | 1.91 | 31.3 |
| 3L15R1 | 41.90 | 6.90 | 1.46 | 90.3 |
| 3L15R2 | −42.20 | 0.60 | | |
| 3L16R1 | 141.90 | 8.00 | 1.46 | 90.3 |
| 3L16R2(*) | −30.90 | 0.30 | | |
| 3L17R1 | 110.10 | 4.50 | 1.46 | 90.3 |
| 3L17R2 | −116.00 | 14.70 | | |
| Prism | Inf. | 31.40 | 1.52 | 64.2 |

3B

| Zoom | Wide | Tele |
|---|---|---|
| 3L6R2 | 2.90 | 2.00 |
| 3L7R2 | 27.80 | 0.90 |
| 3L8R2 | 9.50 | 21.20 |
| 3L9R2 | 8.60 | 11.90 |
| 3L16R2 | 0.30 | 13.10 |

3C

| (A) | | | | | | |
|---|---|---|---|---|---|---|
| Aspheric | | | | | | |
| coefficient | 3L1R1 | 3L1R2 | 3L3R1 | 3L3R2 | 3L12R2 | 3L13R1 |
| K | −43.69 | −0.71 | 15.12 | 0.54 | −0.33 | 1.69 |
| A4 | 6.85E−06 | −9.95E−06 | 1.79E−06 | 6.19E−06 | −3.88E−08 | 1.69E−05 |
| A6 | −8.90E−09 | 4.34E−08 | 2.24E−09 | 2.30E−08 | 1.31E−08 | 1.47E−08 |
| A8 | 8.56E−12 | −1.48E−10 | 1.39E−10 | 5.91E−11 | −9.95E−11 | 5.74E−10 |
| A10 | −5.15E−15 | 2.69E−13 | −5.39E−13 | 1.65E−14 | −5.44E−13 | −6.93E−12 |
| A12 | 1.91E−18 | −2.81E−16 | 9.68E−16 | −6.43E−16 | 1.23E−14 | 5.03E−14 |
| A14 | −4.01E−22 | 1.52E−19 | −8.37E−19 | 1.58E−18 | −7.17E−17 | −1.44E−16 |
| A16 | 3.71E−26 | −3.36E−23 | 3.19E−22 | −6.22E−22 | 0 | 0 |

The wide angle end of the wide angle zoom projection lens 30 uses a first wavelength λ1 of 620 nm, a second wavelength λ2 of 550 nm and a third wavelength λ3 of 460 nm to match relative field heights, which are 0.00, 0.20, 0.40, 0.60, 0.80, 1.00 to respectively simulate the corresponding ray aberration FIG. 3C, and viewing the Y-FAN ray aberration and the X-FAN field aberrations diagram can tell the maximum aberration at each field of view point is controlled within the range of −0.03 mm˜0.03 mm; The wide angle end of the wide angle zoom projection lens 30 uses a first wavelength λ1 of 620 nm, a second wavelength λ2 of 550 nm and a third wavelength λ3 of 460 nm to match relative field heights, which are 0.00, 0.20, 0.40, 0.60, 0.80, 1.00 to respectively simulate the corresponding ray aberration FIG. 3D, and viewing the Y-FAN ray aberration and the X-FAN field aberrations diagram can tell the maximum aberration at each field of view point is controlled within the range of −0.03 mm˜0.02 mm.

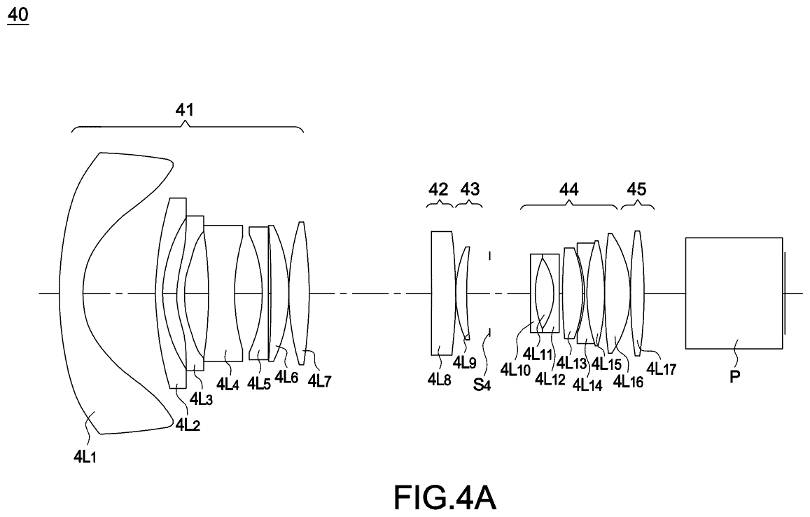

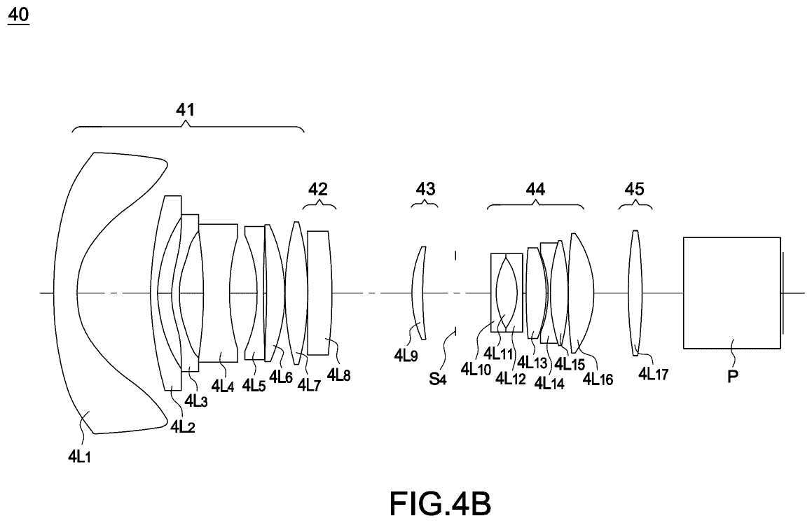

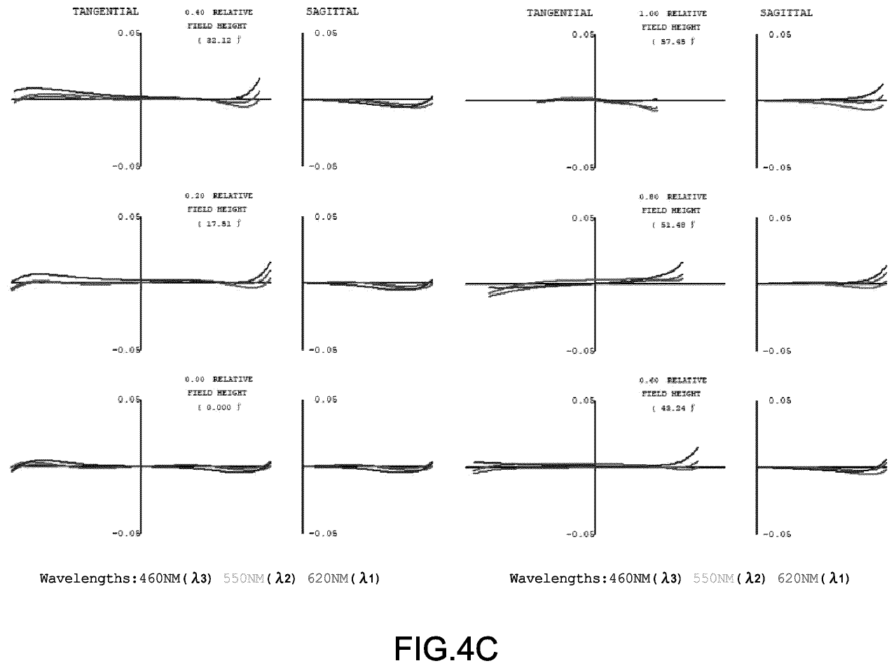

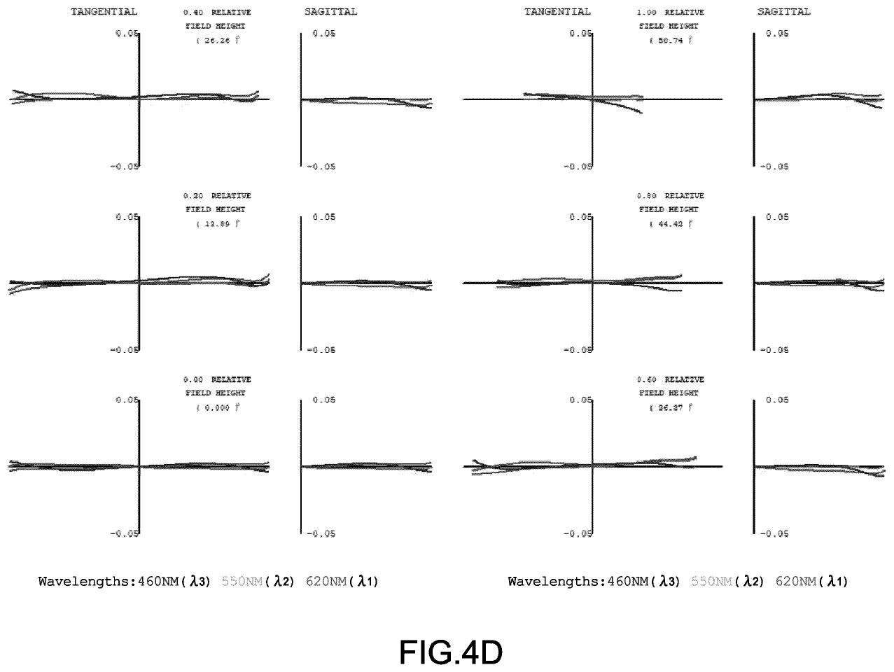

Referring to FIGS. 4A and 4B, the fourth embodiment of the present invention includes a wide angle zoom projection lens 40, which from the magnifying side to the narrowing side of the lens sequentially comprising: a first lens group 41 with negative diopter, a second lens group 42, a third lens group 43 with positive diopter, a fourth lens group 44 with positive diopter, a fifth lens group 45 with positive diopter, and a prism P, then an aperture S4 is arranged between the third lens group 43 and the fourth lens group 44 or arranged in the fourth lens group 44, the F value of the aperture S4 is between 1.8˜1.94; during the zooming, the first lens group 41 and the fifth lens group 45 are fixed, the second 42 to fourth lens group 44 move along the optical axis to achieve changes in focal length; The front lens of the first lens group 41 closest to the magnifying side of the lens is an aspherical lens with negative diopter to achieve a wide angle effect, the narrowing side of the lens has telecentric characteristics; wherein, Ww/Dw=1.977, |ft/fw|=1.275, |f1/fw|=4.363, |f4/fw|=24.203, Bf/fw=4.697, CA/IHm=8.641, Ww is the projection screen width of wide angle end, Dw is the projection distance at the wide angle end, ft is the focal length of the entire lens at the telephoto end, fw is the focal length of the entire lens at the wide angle end, f1 is the focal length of the first lens group, f4 is the focal length of the fourth lens group, Bf is the back focal length when converted to air, CA is the effective diameter of the front lens, and IHm is the maximum image height on the narrowing side of the lens.

The lens parameters design of the wide angle zoom projection lens 40 are shown in Table 4A, Table 4B and Table 4C below; Wherein 4L1R1 is the magnifying side surface R1 of the first lens 4L1, and 4L1R2 is the narrowing side surface R2 of the first lens 4L1, 4L2R1 is the magnifying side surface R1 of the second lens 4L2, 4L2R2 is the narrowing side surface R2 of the second lens 4L2, . . . 4L17R1 is the magnifying side surface R1 of the seventeenth lens 4L17, 4L17R2 is the narrowing side surface R2 of the seventeenth lens 4L17, and so on; and the tenth lens 4L10, the eleventh lens 4L11 and the twelfth lens 4L12 can form a doublet, and the fourteenth lens 4L14 and the fifteenth lens 4L15 can form a doublet.

4A

| Embodiment 4 | Radius(mm) | Thickness(mm) | Nd | Vd |
|---|---|---|---|---|
| 4L1R1(A) | 881.20 | 7.00 | 1.51 | 56.3 |
| 4L1R2(A) | 28.80 | 24.00 | | |
| 4L2R1 | 98.50 | 2.50 | 1.46 | 90.3 |
| 4L2R2 | 36.90 | 4.40 | | |
| 4L3R1(A) | 22.00 | 2.30 | 1.51 | 56.3 |
| 4L3R2(A) | 19.50 | 8.60 | | |
| 4L4R1 | −82.90 | 7.80 | 1.59 | 68.6 |
| 4L4R2 | 54.70 | 9.30 | | |
| 4L5R1 | −35.60 | 1.40 | 1.76 | 52.3 |
| 4L5R2 | 345.40 | 1.50 | | |
| 4L6R1 | −210.00 | 5.50 | 1.79 | 25.7 |
| 4L6R2 | −44.20 | 0.20 | | |
| 4L7R1 | 70.90 | 6.80 | 1.70 | 30.1 |
| 4L7R2(*) | −102.20 | 39.50 | | |
| 4L8R1 | −459.30 | 7.90 | 1.70 | 30.1 |
| 4L8R2(*) | −123.90 | 0.20 | | |
| 4L9R1 | 34.80 | 3.20 | 1.70 | 30.1 |
| 4L9R2(*) | 74.20 | 8.50 | | |
| Stop(S4) | Inf. | 10.80 | | |
| 4L10R1 | 306.40 | 3.00 | 1.91 | 31.3 |
| 4L11R1 | 22.60 | 7.30 | 1.52 | 64.2 |
| 4L12R1 | −16.00 | 1.00 | 1.91 | 31.3 |
| 4L12R2(A) | −126.60 | 0.20 | | |
| 4L13R1(A) | 50.40 | 7.00 | 1.59 | 59.4 |
| 4L13R2 | −33.80 | 0.20 | | |
| 4L14R1 | −49.70 | 1.30 | 1.91 | 31.3 |
| 4L15R1 | 46.80 | 6.10 | 1.46 | 90.3 |
| 4L15R2 | −48.70 | 0.20 | | |
| 4L16R1 | 170.20 | 7.80 | 1.44 | 94.6 |
| 4L16R2(*) | −29.10 | 0.20 | | |
| 4L17R1 | 114.20 | 4.30 | 1.46 | 90.3 |
| 4L17R2 | −126.50 | 14.60 | | |
| Prism | Inf. | 31.40 | 1.52 | 64.2 |

4B

| Zoom | Wide | Tele |
|---|---|---|
| 4L7R2 | 39.50 | 0.60 |
| 4L8R2 | 0.20 | 25.20 |
| 4L9R2 | 8.50 | 10.90 |
| 4L16R2 | 0.20 | 11.60 |

4C

| (A) | | | | | | |
|---|---|---|---|---|---|---|
| Aspheric | | | | | | |
| coefficient | 4L1R1 | 4L1R2 | 4L3R1 | 4L3R2 | 4L12R2 | 4L13R1 |
| K | 19.04 | −0.65 | −2.45 | −0.84 | −3.85 | 3.29 |
| A4 | 1.09E−05 | 9.74E−06 | −4.48E−05 | −6.58E−05 | −2.98E−06 | 1.42E−05 |
| A6 | −1.39E−08 | 1.15E−08 | 4.25E−09 | 6.80E−08 | 3.31E−09 | 9.96E−09 |
| A8 | 1.29E−11 | −8.91E−11 | 4.01E−10 | 3.57E−10 | −2.74E−11 | 2.89E−10 |
| A10 | −7.65E−15 | 2.04E−13 | −1.38E−12 | −1.73E−12 | −1.02E−12 | −2.95E−12 |
| A12 | 2.83E−18 | −2.30E−16 | 2.45E−15 | 4.70E−15 | 9.13E−15 | 1.80E−14 |
| A14 | −5.93E−22 | 1.22E−19 | −2.42E−18 | −7.79E−18 | −4.14E−17 | −4.65E−17 |
| A16 | 5.44E−26 | −2.43E−23 | 1.05E−21 | 6.40E−21 | 0 | 0 |

The wide angle end of the wide angle zoom projection lens 40 uses a first wavelength λ1 of 620 nm, a second wavelength λ2 of 550 nm and a third wavelength λ3 of 460 nm to match relative field heights, which are 0.00, 0.20, 0.40, 0.60, 0.80, 1.00 to respectively simulate the corresponding ray aberration FIG. 4C, and viewing the Y-FAN ray aberration and the X-FAN field aberrations diagram can tell the maximum aberration at each field of view point is controlled within the range of −0.02 mm˜0.02 mm; The wide angle end of the wide angle zoom projection lens 40 uses a first wavelength λ1 of 620 nm, a second wavelength λ2 of 550 nm and a third wavelength λ3 of 460 nm to match relative field heights, which are 0.00, 0.20, 0.40, 0.60, 0.80, 1.00 to respectively simulate the corresponding ray aberration FIG. 4D, and viewing the Y-FAN ray aberration and the X-FAN field aberrations diagram can tell the maximum aberration at each field of view point is controlled within the range of −0.02 mm˜0.01 mm.

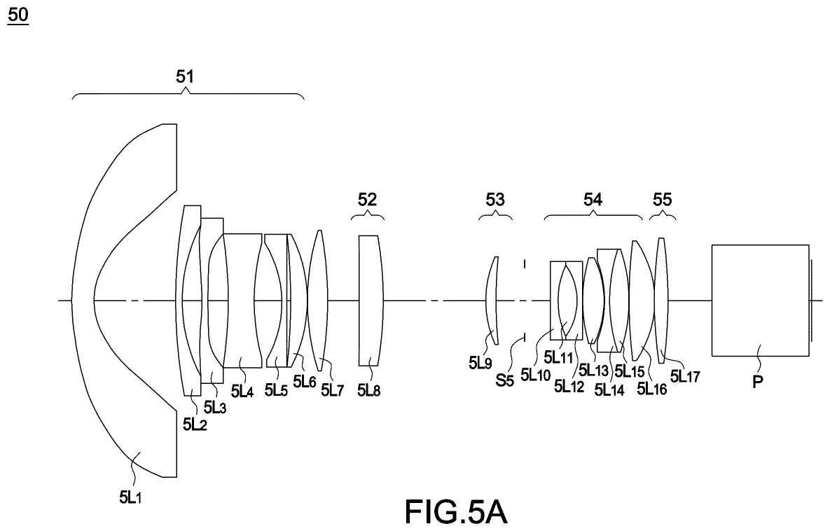

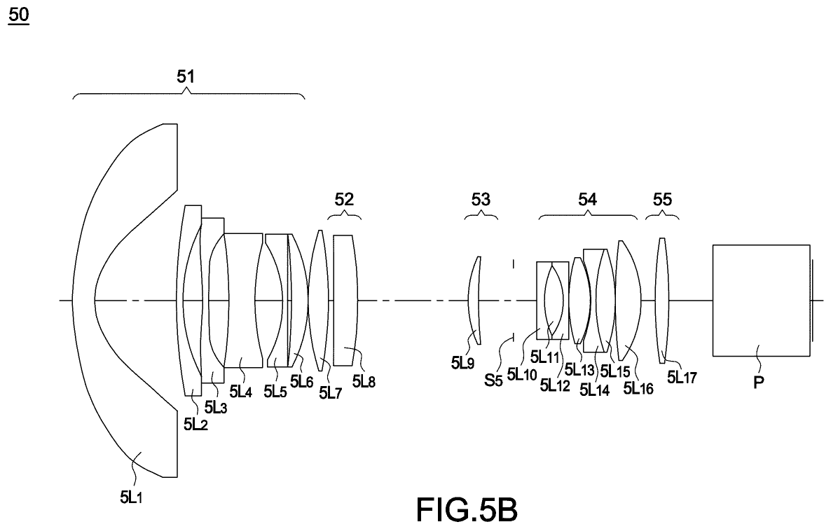

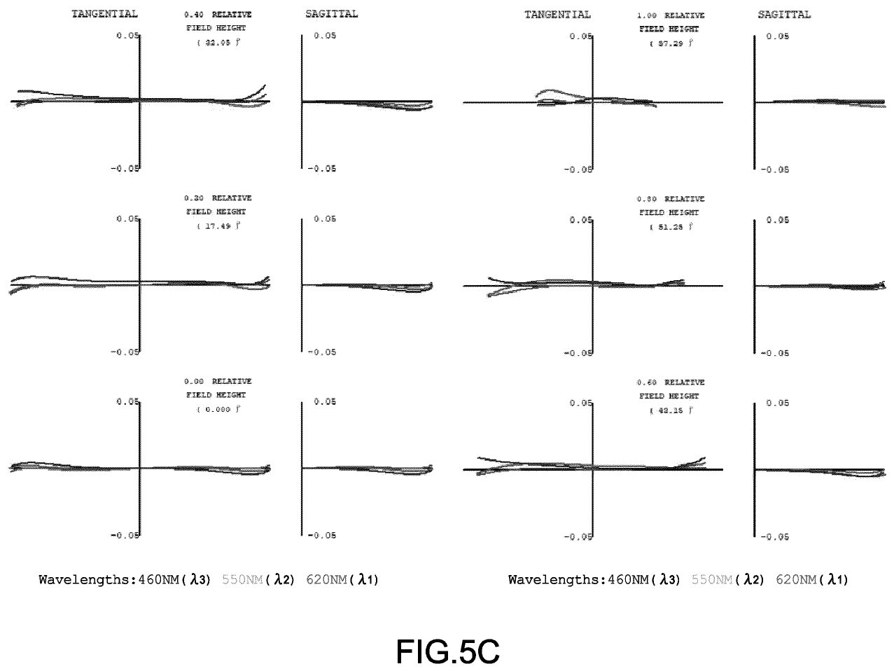

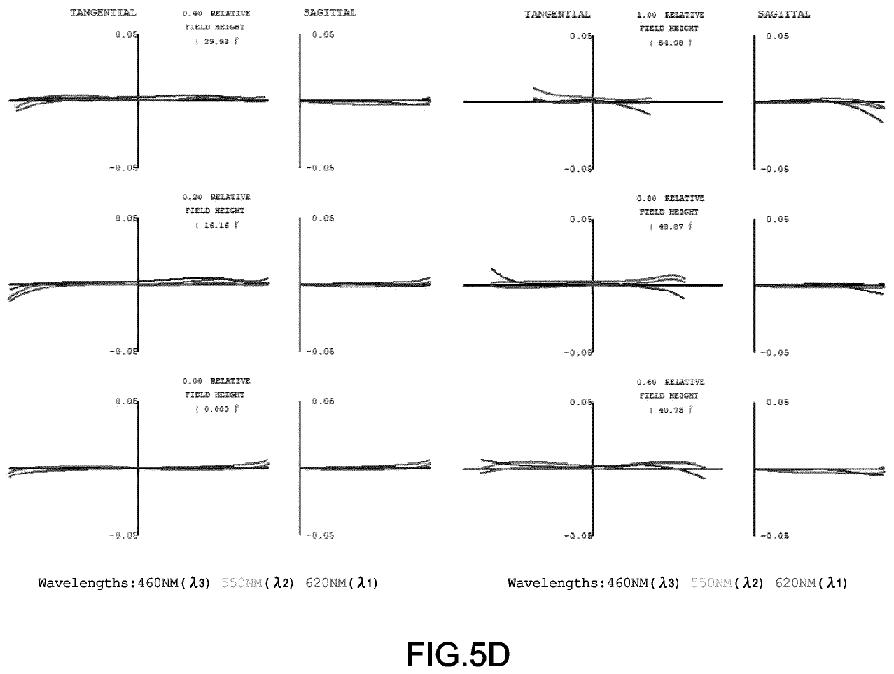

Referring to FIGS. 5A and 5B, the fifth embodiment of the present invention includes a wide angle zoom projection lens 50, which from the magnifying side to the narrowing side of the lens sequentially comprising: a first lens group 51 with negative diopter, a second lens group 52, a third lens group 53 with positive diopter, a fourth lens group 54 with positive diopter, a fifth lens group 55 with positive diopter, and a prism P, then an aperture S5 is arranged between the third lens group 53 and the fourth lens group 54 or arranged in the fourth lens group 54, the F value of the aperture S5 is between 1.8˜1.85; during the zooming, the first lens group 51 and the fifth lens group 55 are fixed, the second 52 to fourth lens group 54 move along the optical axis to achieve changes in focal length; The front lens of the first lens group 51 closest to the magnifying side of the lens is an aspherical lens with negative diopter to achieve a wide angle effect, the narrowing side of the lens has telecentric characteristics; wherein, Ww/Dw=1.989, |ft/fw|=1.088, |f1/fw|=3.242, |f4/fw|=47.374, Bf/fw=4.698, CA/IHm=8.458, Ww is the projection screen width of wide angle end, Dw is the projection distance at the wide angle end, ft is the focal length of the entire lens at the telephoto end, fw is the focal length of the entire lens at the wide angle end, f1 is the focal length of the first lens group, f4 is the focal length of the fourth lens group, Bf is the back focal length when converted to air, CA is the effective diameter of the front lens, and IHm is the maximum image height on the narrowing side of the lens.

The lens parameters design of the wide angle zoom projection lens 50 are shown in Table 5A, Table 5B and Table 5C below; Wherein 5L1R1 is the magnifying side surface R1 of the first lens 5L1, and 5L1R2 is the narrowing side surface R2 of the first lens 5L1, 5L2R1 is the magnifying side surface R1 of the second lens 5L2, 5L2R2 is the narrowing side surface R2 of the second lens 5L2, . . . 5L17R1 is the magnifying side surface R1 of the seventeenth lens 5L17, 5L17R2 is the narrowing side surface R2 of the seventeenth lens 5L17, and so on; and the tenth lens 5L10, the eleventh lens 5L11 and the twelfth lens 5L12 can form a doublet, and the fourteenth lens 5L14 and the fifteenth lens 5L15 can form a doublet.

5A

| Embodiment 5 | Radius(mm) | Thickness(mm) | Nd | Vd |
|---|---|---|---|---|
| 5L1R1(A) | 71.60 | 7.00 | 1.51 | 56.3 |
| 5L1R2(A) | 20.10 | 23.40 | | |
| 5L2R1 | 113.30 | 3.00 | 1.93 | 20.9 |
| 5L2R2 | 43.40 | 7.10 | | |
| 5L3R1(A) | −148.50 | 2.50 | 1.51 | 56.3 |
| 5L3R2(A) | 467.20 | 6.70 | | |
| 5L4R1 | −74.50 | 7.30 | 1.60 | 65.5 |
| 5L4R2 | 58.80 | 9.20 | | |
| 5L5R1 | −39.60 | 1.90 | 1.76 | 52.3 |
| 5L5R2 | 505.60 | 1.50 | | |
| 5L6R1 | −203.10 | 5.50 | 1.79 | 25.7 |
| 5L6R2 | −46.80 | 0.20 | | |
| 5L7R1 | 68.10 | 6.70 | 1.63 | 35.7 |
| 5L7R2(*) | −162.20 | 9.20 | | |
| 5L8R1 | −471.20 | 7.30 | 1.76 | 27.5 |
| 5L8R2(*) | −109.50 | 34.40 | | |
| 5L9R1 | 32.50 | 3.30 | 1.68 | 32.2 |
| 5L9R2(*) | 87.70 | 9.50 | | |
| Stop(S5) | Inf. | 7.30 | | |
| 5L10R1 | 104.00 | 1.00 | 1.91 | 31.3 |
| 5L11R1 | 19.30 | 7.30 | 1.52 | 64.2 |
| 5L12R1 | −16.20 | 1.00 | 1.91 | 31.3 |
| 5L12R2(A) | 2935.00 | 0.20 | | |
| 5L13R1(A) | 48.20 | 7.60 | 1.67 | 55.4 |
| 5L13R2 | −26.80 | 0.20 | | |
| 5L14R1 | −32.60 | 3.30 | 1.91 | 31.3 |
| 5L15R1 | 43.20 | 6.20 | 1.46 | 90.3 |
| 5L15R2 | −45.20 | 0.20 | | |
| 5L16R1 | 170.60 | 7.30 | 1.46 | 90.3 |
| 5L16R2(*) | −29.30 | 0.30 | | |
| 5L17R1 | 142.30 | 4.60 | 1.46 | 90.3 |
| 5L17R2 | −83.20 | 12.70 | | |
| Prism | Inf. | 31.40 | 1.52 | 64.2 |

5B

| Zoom | Wide | Tele |
|---|---|---|
| 5L7R2 | 9.20 | 1.40 |
| 5L8R2 | 34.40 | 36.30 |
| 5L9R2 | 9.50 | 11.30 |
| 5L16R2 | 0.30 | 4.40 |

5C

| (A) | | | | | | |
|---|---|---|---|---|---|---|
| Aspheric | | | | | | |
| coefficient | 5L1R1 | 5L1R2 | 5L3R1 | 5L3R2 | 5L12R2 | 5L13R1 |
| K | −42.38 | −0.71 | 25.52 | −20.77 | −4.91 | 1.93 |
| A4 | 7.78E−06 | −9.05E−06 | −3.04E−06 | 2.35E−06 | −1.79E−07 | 1.79E−05 |
| A6 | −1.23E−08 | 4.68E−08 | 9.52E−08 | 8.35E−08 | −4.87E−09 | 2.26E−08 |
| A8 | 1.35E−11 | −1.97E−10 | −5.49E−10 | −2.35E−10 | 1.91E−10 | 3.25E−10 |
| A10 | −9.05E−15 | 4.18E−13 | 1.88E−12 | −3.38E−13 | −4.23E−12 | −3.64E−12 |
| A12 | 3.68E−18 | −4.86E−16 | −3.52E−15 | 5.21E−15 | 3.15E−14 | 2.69E−14 |
| A14 | −8.35E−22 | 2.89E−19 | 3.41E−18 | −1.35E−17 | −1.12E−16 | −7.76E−17 |
| A16 | 8.21E−26 | −6.89E−23 | −1.34E−21 | 1.20E−20 | 0 | 0 |

The wide angle end of the wide angle zoom projection lens 50 uses a first wavelength λ1 of 620 nm, a second wavelength λ2 of 550 nm and a third wavelength λ3 of 460 nm to match relative field heights, which are 0.00, 0.20, 0.40, 0.60, 0.80, 1.00 to respectively simulate the corresponding ray aberration FIG. 5C, and viewing the Y-FAN ray aberration and the X-FAN field aberrations diagram can tell the maximum aberration at each field of view point is controlled within the range of −0.01 mm˜0.02 mm; The wide angle end of the wide angle zoom projection lens 50 uses a first wavelength λ1 of 620 nm, a second wavelength λ2 of 550 nm and a third wavelength λ3 of 460 nm to match relative field heights, which are 0.00, 0.20, 0.40, 0.60, 0.80, 1.00 to respectively simulate the corresponding ray aberration FIG. 5D, and viewing the Y-FAN ray aberration and the X-FAN field aberrations diagram can tell the maximum aberration at each field of view point is controlled within the range of −0.02 mm˜0.02 mm.

With the feature disclosed above, the first lens 1L1/2L1/3L1/4L1/5L1 of the present invention is an aspherical lens with negative diopter to achieve a wide angle effect; a second lens group Dec. 22, 1932/42/52, a third lens group 13/23/33/43/53, a fourth lens group 14/24/34/44/54, and a fifth lens group 15/25/35 are movable group for achieving zooming projection requirement, at the same time, the aberration, field curvature, distortion and lateral color aberration of the wide angle zoom projection lenses Oct. 20, 1930/40/50 can be controlled within a smaller range when they are at the wide angle end and photography end; therefore, the present invention has the ability to simultaneously satisfy the requirements of high brightness, wide angle and zoom projection needs and maintain the quality of projection imaging.

Although particular embodiment of the invention has been described in detail for purposes of illustration, various modifications and enhancements may be made without departing from the spirit and scope of the invention. Accordingly, the invention is not to be limited except by the appended claims.

What is claimed is:

1. A wide angle zoom projection lens, which from the magnifying side to the narrowing side of the lens sequentially comprising:
a first lens group with negative diopter, a second lens group, a third lens group with positive diopter, a fourth lens group with positive diopter, a fifth lens group with positive diopter, a sixth lens group with positive diopter, and an aperture in the lens; during the zooming, the first lens group and the sixth lens group are fixed, the second to fifth lens groups move along the optical axis to achieve changes in focal length; The front lens of the first lens group closest to the magnifying side of the lens is an aspherical lens with negative diopter to achieve a wide angle effect, the narrowing side of the lens has telecentric characteristics, and 1.3≤Ww/Dw≤2.5, Ww is the projection screen width of wide angle end, Dw is the projection distance at the wide angle end.

2. The wide angle zoom projection lens as claimed in claim 1, wherein 1.05≤|ft/fw|≤1.7, ft is the focal length of the entire lens at the telephoto end, and fw is the focal length of the entire lens at the wide angle end.

3. The wide angle zoom projection lens as claimed in claim 1, wherein an aperture is set between the fourth lens group and the fifth lens group, and the F value of the aperture is between 1.7 and 2.6.

4. The wide angle zoom projection lens as claimed in claim 1, wherein, the first lens group has at least one glass lens with a refractive index≥1.75 and at least one glass lens with an Abbe number≥55, and the fifth lens group has at least one doublet, at least one glass lens with a refractive index≥1.75 and at least one glass lens with Abbe number≥60.

5. The wide angle zoom projection lens as claimed in claim 1, wherein 1.2≤|f1/fw|≤1.7, 4.5≤|f5/fw|≤35.0, fw is the focal length of the entire lens at the wide angle end, f1 is the focal length of the first lens group, and f5 is the focal length of the fifth lens group.

6. The wide angle zoom projection lens as claimed in claim 1, wherein the first lens group can be integrated into a group or divided into multiple groups to adjust focus and field curvature.

7. The wide angle zoom projection lens as claimed in claim 1, wherein 4.0≤Bf/fw≤5.0, fw is the focal length of the entire lens at the wide angle end, and Bf is the back focal length when converted to air.

8. The wide angle zoom projection lens as claimed in claim 1, wherein CA/IHm≤12, CA is the effective diameter of the front lens, and IHm is the maximum image height on the narrowing side of the lens.

9. A wide angle zoom projection lens, which from the magnifying side to the narrowing side of the lens sequentially comprising:
a first lens group with negative diopter, a second lens group, a third lens group with positive diopter, a fourth lens group with positive diopter, a fifth lens group with positive diopter, and an aperture in the lens; during the zooming, the first lens group and the fifth lens group are fixed, the second to fourth lens groups move along the optical axis to achieve changes in focal length; The front lens of the first lens group closest to the magnifying side of the lens is an aspherical lens with negative diopter to achieve a wide angle effect, the narrowing side of the lens has telecentric characteristics, and 1.3≤Ww/Dw≤2.5, Ww is the projection screen width of wide angle end, Dw is the projection distance at the wide angle end.

10. The wide angle zoom projection lens as claimed in claim 9, wherein 1.05≤|ft/fw|≤1.3, ft is the focal length of the entire lens at the telephoto end, and fw is the focal length of the entire lens at the wide angle end.

11. The wide angle zoom projection lens as claimed in claim 9, wherein an aperture is set between the third lens group and the fourth lens group, and the F value of the aperture is between 1.7 and 2.6.

12. The wide angle zoom projection lens as claimed in claim 9, wherein, the first lens group has at least one glass lens with a refractive index≥1.75 and at least one glass lens with an Abbe number≥55, and the fourth lens group has at least one doublet, at least one glass lens with a refractive index≥1.75 and at least one glass lens with Abbe number≥60.

13. The wide angle zoom projection lens as claimed in claim 9, wherein 3≤|f1/fw|≤5, 4.5≤|f4/fw|≤50.0, fw is the focal length of the entire lens at the wide angle end, f1 is the focal length of the first lens group, and f4 is the focal length of the fourth lens group.

14. The wide angle zoom projection lens as claimed in claim 9, wherein the first lens group can be integrated into a group or divided into multiple groups to adjust focus and field curvature.

15. The wide angle zoom projection lens as claimed in claim 9, wherein 4.0≤Bf/fw≤5.0, fw is the focal length of the entire lens at the wide angle end, and Bf is the back focal length when converted to air.

16. The wide angle zoom projection lens as claimed in claim 9, wherein CA/IHm≤12, CA is the effective diameter of the front lens, and IHm is the maximum image height on the narrowing side of the lens.
